(19) United States
(12) Patent Application Publication
(10) Pub. No.: US 2025/0149249 A1
(43) Pub. Date: May 8, 2025

(54) CERAMIC ELECTRONIC DEVICE AND MANUFACTURING METHOD OF THE SAME

(71) Applicant: TAIYO YUDEN CO., LTD., Tokyo (JP)

(72) Inventors: Hirokazu CHAZONO, Tokyo (JP); Yuta FUSE, Tokyo (JP)

(73) Assignee: TAIYO YUDEN CO., LTD., Tokyo (JP)

(21) Appl. No.: 19/005,655

(22) Filed: Dec. 30, 2024

Related U.S. Application Data
(63) Continuation of application No. PCT/JP2023/031256, filed on Aug. 29, 2023.

(30) Foreign Application Priority Data
Sep. 26, 2022 (JP) 2022-152691

(51) Int. Cl. H01G 4/30; H01G 4/012; H01G 4/12

(52) U.S. Cl. CPC H01G 4/30; H01G 4/012; H01G 4/1227

(57) ABSTRACT

A ceramic electronic device includes a multilayer structure in which each of a plurality of dielectric layers and each of a plurality of internal electrode layers are alternately stacked. In at least one of the plurality of dielectric layers, an average grain size of dielectric grains is 150 nm or less, and a number of the dielectric grains per one metal grain of one of the plurality of internal electrode layers adjacent to the at least one of the plurality of dielectric layers is 5 or more and 35 or less in an extension direction of the one of the plurality of internal electrode layers.

### CROSS-REFERENCE TO RELATED APPLICATION

This application is a continuation application of PCT/JP2023/031256 filed on Aug. 29, 2023, which claims priority to Japanese Patent Application No. 2022-152691 filed on Sep. 26, 2022, the contents of which are herein wholly incorporated by reference.

### FIELD

A certain aspect of the present invention relates to a ceramic electronic device and a manufacturing method of the ceramic electronic device.

### BACKGROUND

As ceramic electronic devices such as multilayer ceramic capacitors become smaller and larger capacity, structures have been disclosed in which dielectric layers are made thinner and multi-stacked (see, for example, Japanese Patent Application Publication No. 2016-143709).

### SUMMARY OF THE INVENTION

According to an aspect of the present invention, there is provided a ceramic electronic device including: a multilayer structure in which each of a plurality of dielectric layers and each of a plurality of internal electrode layers are alternately stacked, wherein in at least one of the plurality of dielectric layers, an average grain size of dielectric grains is 150 nm or less, and a number of the dielectric grains per one metal grain of one of the plurality of internal electrode layers adjacent to the at least one of the plurality of dielectric layers is 5 or more and 35 or less in an extension direction of the one of the plurality of internal electrode layers.

According to another aspect of the present invention, there is provided a manufacturing method of a ceramic electronic device including: firing a multilayer structure obtained by stacking a plurality of stack units in which each of a plurality of internal electrode patterns is formed on each of a plurality of dielectric green sheets, so that in at least one of a plurality of dielectric layers formed from the plurality of dielectric green sheets, an average grain size of dielectric grains is 150 nm or less, and a number of the dielectric grains per one metal grain of one of a plurality of internal electrode layers formed from the plurality of internal electrode patterns adjacent to the at least one of the plurality of dielectric layers is 5 or more and 35 or less in an extension direction of the one of the internal electrode layers.

### BRIEF DESCRIPTION OF THE DRAWINGS

FIG. 1 illustrates a perspective view of a multilayer ceramic capacitor in which a cross section of a part of the multilayer ceramic capacitor is illustrated;

FIG. 2 illustrates a cross sectional view taken along a line A-A of FIG. 1;

FIG. 3 illustrates a cross sectional view taken along a line B-B of FIG. 1;

FIG. 4 is an enlarged cross-sectional view of a vicinity of an external electrode;

FIG. 5 is an enlarged view of an XZ cross section of a capacity section;

FIG. 6 is an enlarged view of an XZ cross section of a capacity section;

FIG. 7 illustrates a manufacturing method of a multilayer ceramic capacitor;

FIG. 8A and FIG. 8B illustrate a forming process of an internal electrode.

### DETAILED DESCRIPTION

When attempting to make the dielectric layers thinner, the electric field strength applied to each dielectric layer relatively increases. Therefore, there is a demand for improved durability and reliability when voltage is applied.

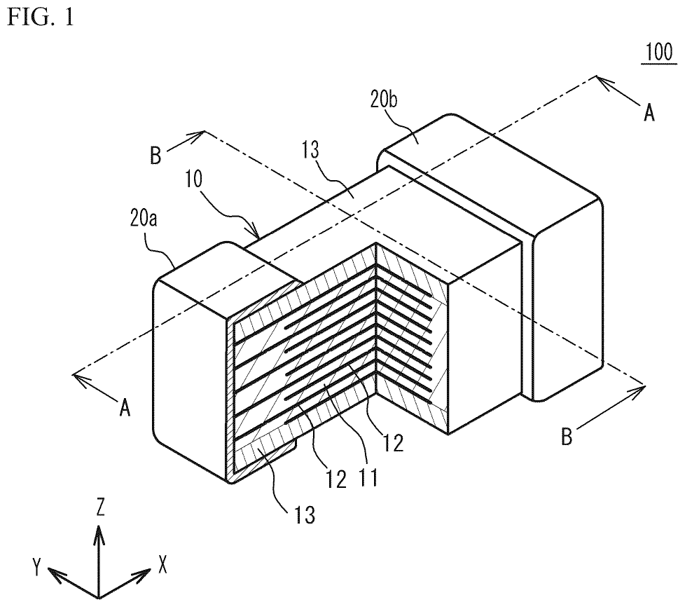

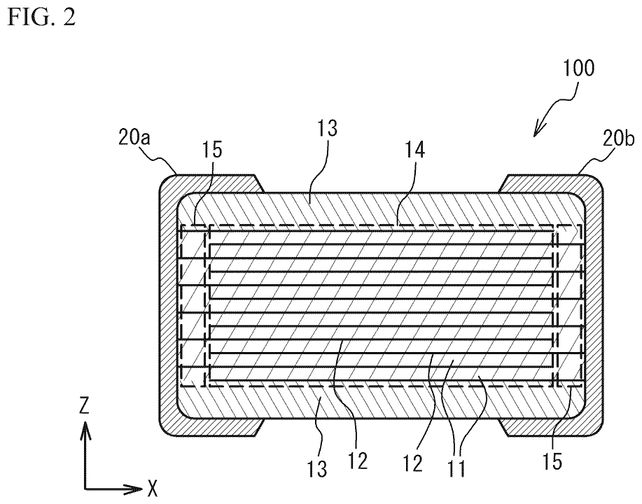

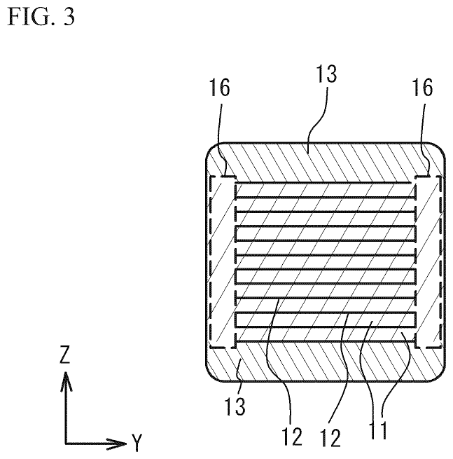

A description will be given of an embodiment with reference to the accompanying drawings.
(Embodiment) FIG. 1 illustrates a perspective view of a multilayer ceramic capacitor 100 in accordance with an embodiment, in which a cross section of a part of the multilayer ceramic capacitor 100 is illustrated. FIG. 2 illustrates a cross sectional view taken along a line A-A of FIG. 1. FIG. 3 illustrates a cross sectional view taken along a line B-B of FIG. 1. As illustrated in FIG. 1 to FIG. 3, the multilayer ceramic capacitor 100 includes a multilayer chip 10 having a rectangular parallelepiped shape, and a pair of external electrodes 20a and 20b that are respectively provided at two end faces of the multilayer chip 10 facing each other. In four faces other than the two end faces of the multilayer chip 10, two faces other than an upper face and a lower face of the multilayer chip 10 in a stacking direction are referred to as side faces. The external electrodes 20a and 20b extend to the upper face, the lower face and the two side faces of the multilayer chip 10. However, the external electrodes 20a and 20b are spaced from each other.

In FIG. 1 to FIG. 3, a Z-axis direction is a stacking direction, and is the direction in which the internal electrode layers 12 face each other. An X-axis direction is a length direction of the multilayer chip 10, and is the direction in which the two end faces of the multilayer chip 10 face each other, and is the direction in which the external electrodes 20a and 20b face each other. A Y-axis direction is a width direction of the internal electrode layers 12, and is the direction in which the two side faces other than the two end faces of four side faces of the multilayer chip 10 face each other. The X-axis direction, the Y-axis direction, and the Z-axis direction are mutually orthogonal to each other.

The multilayer chip 10 has a configuration in which dielectric layers 11 containing a ceramic material that functions as a dielectric and the internal electrode layers 12 are alternately stacked. The edges of the internal electrode layers 12 are alternately exposed to the end face of the multilayer chip 10 on which the external electrode 20a is provided and the end face on which the external electrode 20b is provided. As a result, each of the internal electrode layers 12 is alternately conductive to the external electrode 20a and the external electrode 20b. As a result, the multilayer ceramic capacitor 100 has a configuration in which the dielectric layers 11 are stacked through the internal electrode layers 12. In addition, in the multilayer structure of the dielectric layers 11 and the internal electrode layers 12, the internal electrode layers 12 are arranged on both outermost layers in the stacking direction, and the internal electrode layers 12 of the outermost layers are covered by cover layers 13. The cover layers 13 are mainly composed of a ceramic material. For example, the cover layers 13 may have the same composition as the dielectric layers 11 or may have a different composition. As long as the internal electrode layers 12 are exposed on two different faces and are electrically connected to different external electrodes, the configurations are not limited to those illustrated in FIG. 1 to FIG. 3

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The internal electrode layers 12 are mainly composed of base metals such as nickel (Ni), copper (Cu), or tin (Sn), or alloys thereof. As the main component of the internal electrode layers 12, noble metals such as platinum (Pt), palladium (Pd), silver (Ag), or gold (Au), or alloys containing these metals, may be used. The average thickness per layer of the internal electrode layers 12 in the Z-axis direction is, for example, 0.6 μm or less, and preferably 0.4 μm or less. The average thickness per layer of the internal electrode layers 12 can be measured by observing the cross section of the multilayer ceramic capacitor 100 with a SEM (scanning electron microscope), measuring the thickness at 10 points for each of the 10 different internal electrode layers 12, and deriving the average value of all the measurement points.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) having a perovskite structure. Ba_{1-x-y}CaₓSr_{y}Ti_{1-z}Zr_{z}O₃ may be barium strontium titanate, barium calcium titanate, barium zirconate, barium titanate zirconate, calcium titanate zirconate, barium calcium titanate zirconate or the like. For example, the dielectric layers 11 contain 90 at % or more of the main component ceramic. The average thickness of each of the dielectric layers 11 in the Z-axis direction is, for example, 0.5 μm or less, and preferably 0.3 μm or less. The average thickness of each of the dielectric layers 11 in the Z-axis direction can be measured by observing a cross section of the multilayer ceramic capacitor 100 with a SEM (scanning electron microscope), measuring the thickness at 10 points for each of 10 different dielectric layers 11, and deriving the average value of all the measurement points.

Additives may be added to the dielectric layer 11. As additives to the dielectric layer 11, an oxide of Zr (zirconium), Hf (hafnium), Mg (magnesium), Mn (manganese), Mo (molybdenum), vanadium (V), chromium (Cr), or a rare earth element (Y (yttrium), Sn (samarium), Eu (europium), Gd (gadolinium), Tb (terbium), Dy (dysprosium), Ho (holmium), Er (erbium), Tm (thulium) or Yb (ytterbium), or an oxide of Co (cobalt), Ni (nickel), Li (lithium), B (boron), Na (sodium), K (potassium) or Si (silicon), or a glass including cobalt, nickel, lithium, boron, sodium, potassium or silicon.

As illustrated in FIG. 2, a section, in which a set of the internal electrode layers 12 connected to the external electrode 20a face another set of the internal electrode layers 12 connected to the external electrode 20b, is a section generating electrical capacity in the multilayer ceramic capacitor 100. Accordingly, the section is referred to as a capacity section 14. That is, the capacity section 14 is a section in which the internal electrode layers next to each other being connected to different external electrodes face each other.

A section, in which the internal electrode layers 12 connected to the external electrode 20a face each other without sandwiching the internal electrode layer 12 connected to the external electrode 20b, is referred to as an end margin 15. A section, in which the internal electrode layers 12 connected to the external electrode 20b face each other without sandwiching the internal electrode layer 12 connected to the external electrode 20a is another end margin 15. That is, the end margin 15 is a section in which a set of the internal electrode layers 12 connected to one external electrode face each other without sandwiching the internal electrode layer 12 connected to the other external electrode. The end margins 15 are sections that do not generate electrical capacity in the multilayer ceramic capacitor 100.

As illustrated in FIG. 3, a section of the multilayer chip 10 from the two sides thereof to the internal electrode layers 12 is referred to as a side margin 16. That is, the side margin 16 is a section covering edges of the stacked internal electrode layers 12 in the extension direction toward the two side faces. The side margin 16 does not generate electrical capacity.

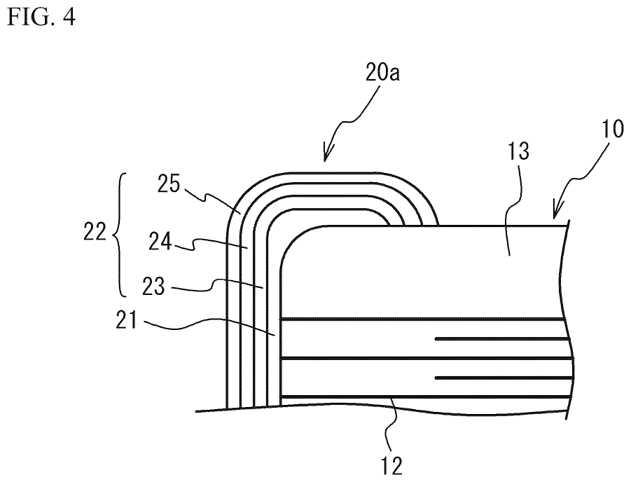

FIG. 4 is an enlarged cross-sectional view of the vicinity of the external electrode 20a. Hatching is omitted in FIG. 4. As illustrated in FIG. 4, the external electrode 20a has a structure in which a plated layer 22 is provided on a base layer 21. The base layer 21 is mainly composed of Cu. The base layer 21 may also contain a glass component. The plated layer 22 is mainly composed of a metal such as Cu, Ni, aluminum (Al), zinc (Zn), Sn, or an alloy of two or more of these. The plated layer 22 may be a plated layer of a single metal component, or may be a plurality of plating layers of different metal components. For example, the plated layer 22 has a structure in which a first plated layer 23, a second plated layer 24, and a third plated layer 25 are formed in this order from the base layer 21 side. The first plated layer 23 is, for example, a Cu plated layer. The second plated layer 24 is, for example, a Ni plated layer. The third plated layer 25 is, for example, a Sn plated layer. Although FIG. 4 illustrates the external electrode 20a, the external electrode 20b also has a similar multilayer structure.

In order to realize a small size and large capacity in such a structure, it is conceivable to make the dielectric layers 11 thinner and increase the number of layers. However, when the dielectric layers 11 are made thinner, the electric field strength applied to each of the dielectric layers 11 increases relatively. Therefore, it is required to improve durability and reliability when a voltage is applied. The multilayer ceramic capacitor 100 according to this embodiment has a configuration that can improve durability and reliability when a voltage is applied.

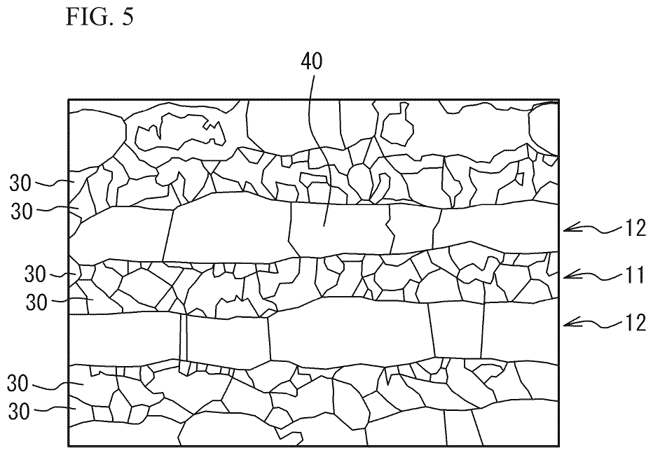

FIG. 5 is an enlarged view of the XZ cross section of the capacity section 14. As illustrated in FIG. 5, the dielectric layer 11 has a structure in which a plurality of dielectric grains 30 are sintered. In order to increase the effective electrostatic capacity of the multilayer ceramic capacitor 100, it is conceivable to lower the relative dielectric constant of the dielectric layer 11. In order to lower the relative dielectric constant of the dielectric layer 11, it is preferable that the dielectric grains 30 have a small grain size. Therefore, in this embodiment, the dielectric grains 30 have an average grain size of 150 nm or less.

As illustrated in FIG. 5, the internal electrode layer 12 has a structure in which a plurality of metal grains 40 are sintered. From the viewpoint of concentrating the normal line component of the electric field in the internal electrode layer 12 rather than in the dielectric layer 11, it is preferable to make the average grain size of the metal grains 40 larger than the average grain size of the dielectric grains 30 of the adjacent dielectric layer 11. Therefore, in this embodiment, in the dielectric layer 11, the number of dielectric grains 30 relative to one metal grain 40 of the adjacent internal electrode layer 12 is 5 or more, preferably 10 or more, and more preferably 15 or more in the direction in which the internal electrode layer 12 extends (X direction). For example, the number of dielectric grains 30 relative to one metal grain 40 may be the number of dielectric grains 30 arranged in contact with the metal grain 40 in the direction in which the internal electrode layer 12 extends.

With this configuration, the normal line component of the electric field is concentrated in the internal electrode layer 12 rather than in the dielectric layer 11, so that the electric field intensity applied to the dielectric layer 11 is lowered, and durability and reliability during voltage application can be improved. Note that if the dielectric grains 30 become fine and difficult to uniformize, the smoothness of the dielectric layer 11 may be degraded. Therefore, in the present embodiment, in the dielectric layer 11, the number of dielectric grains 30 per one metal grain 40 of the adjacent internal electrode layer 12 is 35 or less, preferably 30 or less, and more preferably 25 or less, in the direction in which the internal electrode layer 12 extends.

In FIG. 5, the XZ cross section is focused on, so the direction in which the internal electrode layer 12 extends is the X direction, but this is not limited to this. The direction in which the internal electrode layer 12 extends may be any direction in the XY plane. For example, the direction in which the internal electrode layer 12 extends may be the Y direction.

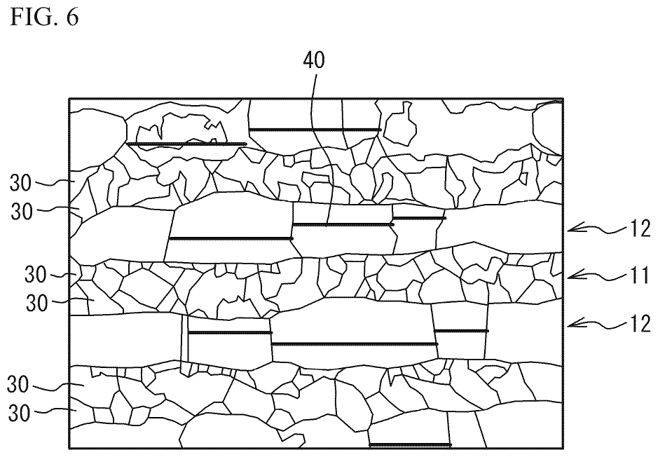

The grain size of the dielectric grains 30 and the metal grains 40 can be measured based on a photograph obtained by photographing a partial cross section of the multilayer chip 10 with, for example, a scanning electron microscope (SEM). Before observing with the SEM, the multilayer ceramic capacitor 100 can be cut, for example, by ion milling, to obtain a smooth cross section suitable for SEM observation. In addition, in order to clearly photograph the grain boundaries, thermal etching may be performed in advance in the same atmosphere as the firing process (mixed gas of N₂, H₂, and H₂O). In this specification, the “average grain size” is defined as the average of the maximum length of the crystal grains after firing in the direction in which the internal electrode layer 12 extends (any direction in the XY plane, perpendicular to the electric field direction), as illustrated in FIG. 6. Regarding the sampling of the dielectric grains to measure the average grain size, the number of samples is set to 100 or more, and if there are 100 or more at one observation site (for example, one photograph at a magnification of 30,000 times with an SEM), all of the dielectric grains therein are sampled, and if there are less than 100, observation (photography) is performed at multiple locations until there are 100 or more.

Since it is preferable that the dielectric grains 30 have a small grain size, the average grain size of the dielectric grains 30 is preferably 110 nm or less, and more preferably 80 nm or less.

On the other hand, if the dielectric grains 30 have an excessively small grain size, the capacity change rate may increase and the temperature characteristics may deteriorate. Therefore, it is preferable to set a lower limit on the average grain size of the dielectric grains 30. In this embodiment, the average grain size of the dielectric grains 30 is preferably 40 nm or more, more preferably 50 nm or more, and even more preferably 80 nm or more.

If the average grain size of the metal grains 40 is large, sintering may not proceed and the continuity modulus of the internal electrode layer 12 may deteriorate. Therefore, it is preferable to set an upper limit on the average grain size of the metal grains 40. In this embodiment, the average grain size of the metal grains 40 in the direction in which the internal electrode layer 12 extends is preferably 1.4 μm or less, more preferably 1.2 μm or less, and even more preferably 1.0 μm or less.

On the other hand, if the average grain size of the metal grains 40 is small, excessive sintering may occur, causing the internal electrode layer 12 to become spherical, and the continuity modulus to deteriorate. Therefore, it is preferable to set a lower limit on the average grain size of the metal grains 40. In this embodiment, the average grain size of the metal grains 40 in the direction in which the internal electrode layer 12 extends is preferably 0.6 μm or more, more preferably 0.7 μm or more, and even more preferably 0.8 μm or more.

Since the sintering temperature of the internal electrode layer 12 is different from that of the dielectric layer 11, it is preferable that the internal electrode layer 12 is formed thicker than the dielectric layer 11 in order to prevent deterioration of continuity modulus to shrinkage caused by sintering. This suppresses shrinkage of the internal electrode layer 12 due to sintering, and suppresses deterioration of the continuity modulus.

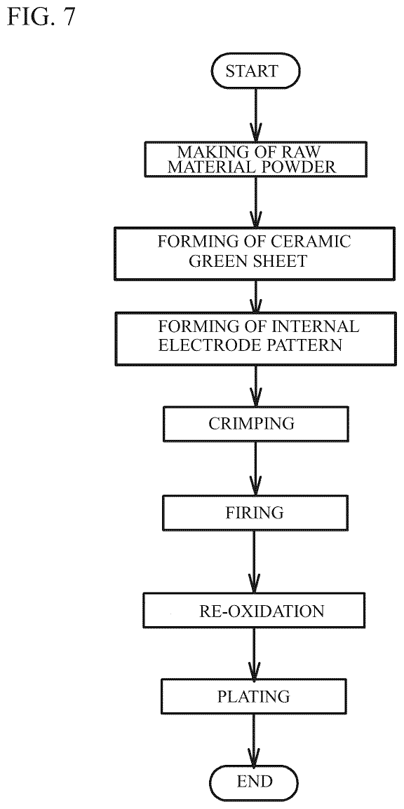

Next, a description will be given of a manufacturing method of the multilayer ceramic capacitors 100. FIG. 7 illustrates a manufacturing method of the multilayer ceramic capacitor 100.
(Making process of raw material powder) A dielectric material for forming the dielectric layer 11 is prepared. The dielectric material includes the main component ceramic of the dielectric layer 11. Generally, an A site element and a B site element are included in the dielectric layer 11 in a sintered phase of grains of ABO₃. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate. Various methods can be used as a synthesizing method of the ceramic structuring the dielectric layer 11. For example, a solid-phase method, a sol-gel method, a hydrothermal method or the like can be used. The embodiments may use any of these methods.

An additive compound may be added to the resulting ceramic powder, in accordance with purposes. The additive compound may be an oxide of zirconium, hafnium, magnesium, manganese, molybdenum, vanadium, chromium, a rare earth element (yttrium, samarium, europium, gadolinium, terbium, dysprosium, holmium, erbium, thulium or ytterbium), or an oxide containing cobalt, nickel, lithium, boron, sodium, potassium or silicon, or glasses containing cobalt, nickel, lithium, boron, sodium, potassium or silicon.

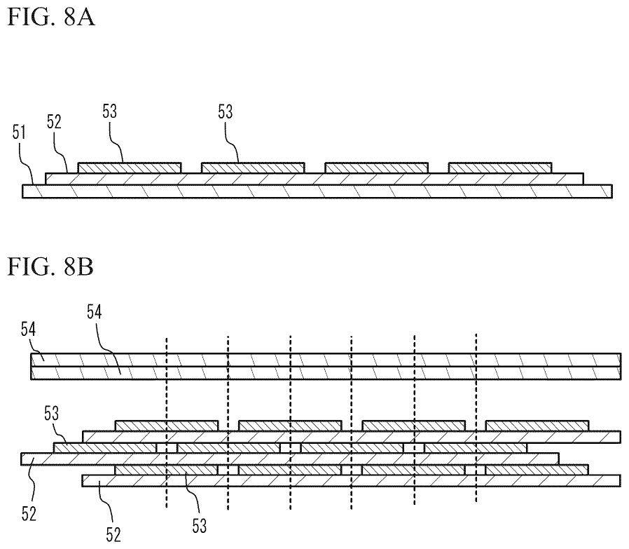

For example, the resulting ceramic raw material powder is wet-blended with additives and is dried and crushed. Thus, a ceramic material is obtained. For example, the particle diameter may be adjusted by crushing the resulting ceramic material as needed. Alternatively, the grain diameter of the resulting ceramic power may be adjusted by combining the crushing and classifying. With the processes, a dielectric material is obtained.
(Forming process of dielectric green sheet) Next, a binder such as polyvinyl butyral (PVB) resin, an organic solvent such as ethanol or toluene, and a plasticizer are added to the resulting dielectric material and wet-blended. With use of the resulting slurry, a dielectric green sheet 52 is formed on a base material 51 by, for example, a die coater method or a doctor blade method, and then dried. The base material 51 is, for example, PET (polyethylene terephthalate) film. The diagram illustrating the forming process of dielectric green sheet is omitted. The thickness of the dielectric green sheet 52 is adjusted in accordance with the thickness of the dielectric layer 11 after firing. For example, the thickness of the dielectric green sheet 52 is set to 0.5 μm or less.
(Forming process of internal electrode) Next, as illustrated in FIG. 8A, an internal electrode pattern 53 is formed on the dielectric green sheet 52. In FIG. 8A, as an example, four parts of the internal electrode pattern 53 are formed on the dielectric green sheet 52 and are spaced from each other. The dielectric green sheet 52 on which the internal electrode pattern 53 is formed is a stack unit.

For the internal electrode pattern 53, a metal paste of the main component metal of the internal electrode layer 12 is used. Ceramic particles are added to the metal paste as a co-material. The main component of the ceramic particles is not particularly limited, but it is preferable that it is the same as the main component ceramic of the dielectric layer 11. For example, BaTiO₃ with an average particle size of 50 nm or less may be uniformly dispersed. For example, if the average particle size of the ceramic particles in the dielectric green sheet is an average particle size A and the average particle size of the metal paste in the internal electrode pattern is an average particle size B, the average particle size A:average particle size B is set to 1:5 to 1:10. For example, when the average particle size A is 0.05 μm, the average particle size B may be set to 0.3 μm to 0.5 μm. It is also possible to adding elements that suppress grain growth, such as Mn and Mg and adjust the particle size of the dielectric.
(Crimping process) Next, the dielectric green sheets 52 are peeled from the base materials 51. As illustrated in FIG. 8B, the stack units are stacked. Next, a predetermined number of cover sheets 54 (for example, 2 to 10 layers) are stacked on the top and bottom of the multilayer structure obtained by stacking the stack units, and are thermally crimped, and then cut to a predetermined chip size. In FIG. 8B, cutting is performed along the dotted lines. The cover sheet 54 may be of the same composition as the dielectric green sheet 52, or may have a different additive.
(Firing process) The binder is removed from the ceramic multilayer structure in N₂ atmosphere at 250 degrees C. to 500 degrees C. A metal paste to be the base layer of the external electrodes 20a and 20b is applied to the both end faces of the ceramic multilayer structure by a dipping method. The resulting ceramic multilayer structure is fired for 10 minutes to 2 hours in a reductive atmosphere having an oxygen partial pressure of 10⁻¹² to 10⁻⁹ MPa in a temperature range of 1100 degrees C. to 1300 degrees C. Each compound constituting the dielectric green sheet is sintered and grains grow. In this manner, the dielectric layers 11 and the internal electrode layers 12 made of sintered bodies are alternately stacked to obtain the multilayer structure 10 having a cover layer formed as the outermost layer.
(Re-oxidizing process) In order to return oxygen to the barium titanate, which is the partially reduced main phase of the dielectric layer 11 fired in a reducing atmosphere, a heat treatment may be performed in a mixed gas of N₂ and water vapor at about 1000° C. or in the air at 500° C. to 700° C., to the extent that the internal electrode layer 12 is not oxidized. This process is called a re-oxidation treatment process.
(Plating process) Thereafter, the base layers of the external electrodes 20a, 20b are plated with a metal coating of copper, nickel, tin, or the like. Through the above steps, the multilayer ceramic capacitor 100 is completed.

According to the manufacturing method according to the present embodiment, the average grain size of the dielectric grains 30 in the dielectric layer 11 obtained from the dielectric green sheet 52 is 150 nm or less. In addition, the number of the dielectric grains 30 for one grain of the internal electrode layer 12 adjacent to the dielectric layer 11 among the internal electrode layers 12 obtained from the internal electrode pattern 53 is 5 to 35 in the direction in which the adjacent internal electrode layer 12 extends. As a result, the normal line component of the electric field is concentrated in the internal electrode layer 12 rather than in the dielectric layer 11, so that the electric field strength applied to the dielectric layer 11 is lowered, and durability and reliability during voltage application can be improved.

In addition, in the above example, the base layer 21 is fired simultaneously when the multilayer structure 10 is fired, but this is not limited to this. For example, after firing the multilayer structure 10, the base layer 21 may be formed by firing a conductive paste on both ends of the multilayer structure 10. Alternatively, the base layer 21 may be formed as a thick film on both end faces of the multilayer structure by a sputtering method or the like.

In the embodiments, the multilayer ceramic capacitor is described as an example of ceramic electronic devices. However, the embodiments are not limited to the multilayer ceramic capacitor. For example, the embodiments may be applied to another electronic device such as varistor or thermistor.

### Examples

The multilayer ceramic capacitors according to the embodiment was fabricated and their characteristics were examined.
(Example 1) Barium titanate was used as the main component ceramic of the ceramic raw material powder for forming the dielectric layer. The average particle diameter of barium titanate was 0.1 μm. Next, ethanol, toluene, and IPA (isopropyl alcohol) were mixed in a ratio of 3:2:1 to obtain barium titanate containing additives. After that, the mixture was dispersed for a predetermined time using a bead mill. Polyvinyl butyral (PVB) and a plasticizer were added as an organic binder to the obtained slurry and kneaded. After that, a dielectric green sheet was produced using a reverse coater.

A metal conductive paste containing Ni metal powder, a binder, a solvent, and other auxiliary agents as necessary was prepared. The organic binder and solvent of the metal conductive paste were different from those of the dielectric green sheet. The first pattern of the metal conductive paste was screen-printed on the dielectric green sheet.

200 dielectric green sheets with the first pattern printed on them were stacked, and cover sheets were stacked on the top and bottom of each. Then, by thermal crimping, a pre-fired multilayer structure was obtained, and cut into a predetermined shape. Then, after removing the binder in an N₂ atmosphere, the multilayer structure was fired to obtain a sintered body (a fired multilayer structure). The firing temperature was 1220° C. The firing was performed in a reducing atmosphere so that the metal components in the metal conductive paste would not oxidize. Then, external electrodes were formed on both ends, and a 1005 type (length 1.0 mm, width 0.5 mm, height 0.5 mm) multilayer ceramic capacitor 100 was obtained.

The thickness of the dielectric layer 11 after firing was 0.3 μm. The average grain size of the dielectric layer was 150 nm, and the average number of dielectric grains per internal electrode particle was 5. The average grain size of the internal electrode layers was 1.0 μm.
(Example 2) In Example 2, the particle size of the ceramic raw material powder was adjusted so that the average grain size of the dielectric layer was 110 nm. As a result, the average number of dielectric grains per internal electrode grain was 6. The other conditions were the same as in Example 1.
(Example 3) In Example 3, the particle size of the ceramic raw material powder was adjusted so that the average grain size of the dielectric layer was 40 nm. As a result, the average number of dielectric grains per internal electrode grain was 35. The other conditions were the same as in Example 1.
(Comparative Example 1) In Comparative Example 1, the particle size of the ceramic raw material powder was adjusted so that the average grain size of the dielectric layer was 30 nm. However, the average particle size became too fine, and the smoothness of the dielectric layer was reduced, so it was not possible to stack the dielectric layer.
(Comparative Example 2) In Comparative Example 2, the particle size of the ceramic raw material powder was adjusted so that the average grain size of the dielectric layer was 250 nm. As a result, the average number of dielectric grains per internal electrode grain was 3. The other conditions were the same as in Example 1.
(High-Temperature Accelerated Life) In order to examine the durability and reliability when voltage is applied to Examples 1 to 3 and Comparative Example 2, the HALT (Highly Accelerated Limit Test) failure rate was measured. In measuring the HALT failure rate, a HALT test of 100 pieces at 125° C., 12 Vdc, 120 min was performed, and a short failure rate of less than 10% was judged to be good (o), and the short failure rate of 10% or more was judged to be bad (x). The results are shown in Table 1.

TABLE 1

| | | NUMBER | | |
|---|---|---|---|---|
| | | OF | AVERAGE | |
| | AVERAGE | DIELEC- | GRAIN | HIGH |
| | GRAIN | TRIC | SIZE OF | TEMPER- |
| | SIZE OF | GRAIN/ | INTERNAL | ATURE |
| | DIELEC- | ONE | ELECTRODE | ACCEL- |
| | TRIC | METAL | LAYER | ERATED |
| | (nm) | GRAIN | (μm) | LIFE |
| EXAMPLE 1 | 150 | 5 | 1.0 | ◯ |
| EXAMPLE 2 | 110 | 6 | 1.0 | ◯ |
| EXAMPLE 3 | 40 | 35 | 1.0 | ◯ |
| COMPAR- | 250 | 3 | 1.0 | X |
| ATIVE | | | | |
| EXAMPLE 2 | | | | |

In Examples 1 to 3, the high-temperature accelerated life test was judged to be good (o). This is thought to be because the number of dielectric grains per one grain of the internal electrode layer adjacent to the dielectric layer was 5 or more and 35 or less in the extension direction of the adjacent internal electrode layer, the normal line component of the electric field was concentrated in the internal electrode layer rather than the dielectric layer, and the electric field strength applied to the dielectric layer was lower. In contrast, in Comparative Example 2, the high-temperature accelerated life test was judged to be bad (x). This is thought to be because the number of dielectric grains per one grain in the internal electrode layer adjacent to the dielectric layer was less than 5 in the extension direction of the adjacent internal electrode layer, and the electric field strength applied to the dielectric layer was higher.

Although the embodiments of the present invention have been described in detail, it is to be understood that the various change, substitutions, and alterations could be made hereto without departing from the spirit and scope of the invention.

1. A ceramic electronic device comprising:
a multilayer structure in which each of a plurality of dielectric layers and each of a plurality of internal electrode layers are alternately stacked,
wherein in at least one of the plurality of dielectric layers, an average grain size of dielectric grains is 150 nm or less, and a number of the dielectric grains per one metal grain of one of the plurality of internal electrode layers adjacent to the at least one of the plurality of dielectric layers is 5 or more and 35 or less in an extension direction of the one of the plurality of internal electrode layers.

2. The ceramic electronic device as claimed in claim 1,
wherein the average grain size of the dielectric grains in the at least one of the plurality of dielectric layers is 40 nm or more and 110 nm or less.

3. The ceramic electronic device as claimed in claim 1,
wherein an average grain size of metal grains in the one of the plurality of internal electrode layers is 0.6 μm or more and 1.4 μm or less.

4. The ceramic electronic device as claimed in claim 1, wherein a thickness of the at least one of the plurality of dielectric layers is 0.5 μm or less.

5. The ceramic electronic device as claimed in claim 1,
wherein a thickness of the at least one of the plurality of dielectric layers is 0.3 μm or less.

6. The ceramic electronic device as claimed in claim 1, wherein a thickness of the one of the plurality of internal electrode layers is 0.6 μm or less.

7. The ceramic electronic device as claimed in claim 1,
wherein a thickness of the one of the plurality of internal electrode layers is 0.4 μm or less.

8. The ceramic electronic device as claimed in claim 1,
wherein a main component of the dielectric grains is barium titanate.

9. The ceramic electronic device as claimed in claim 1,
wherein a main component of the metal grain is nickel.

10. A manufacturing method of a ceramic electronic device comprising:
firing a multilayer structure obtained by stacking a plurality of stack units in which each of a plurality of internal electrode patterns is formed on each of a plurality of dielectric green sheets, so that in at least one of a plurality of dielectric layers formed from the plurality of dielectric green sheets, an average grain size of dielectric grains is 150 nm or less, and a number of the dielectric grains per one metal grain of one of a plurality of internal electrode layers formed from the plurality of internal electrode patterns adjacent to the at least one of the plurality of dielectric layers is 5 or more and 35 or less in an extension direction of the one of the internal electrode layers.
